(19) United States
(12) Patent Application Publication
(10) Pub. No.: US 2011/0295653 A1
(43) Pub. Date: Dec. 1, 2011

(54) METHOD, COMPUTER PROGRAM PRODUCT, AND COMPUTER FOR MANAGEMENT SYSTEM AND OPERATING CONTROL (MSOC) CAPABILITY MATURITY MODEL (CMM)

(75) Inventor: James W. Finan, Suwanee, GA (US)

(73) Assignee: AT&T INTELLECTUAL PROPERTY I, L.P., Reno, NV (US)

(21) Appl. No.: 12/788,588

(22) Filed: May 27, 2010

(51) Int. Cl. G06Q 10/00

(52) U.S. Cl. 705/7.38

(57) ABSTRACT

A method is provided for assessing implementation of Management System and Operating Control (MSOC) by an organization. Matrixes for key process areas of the MSOC are displayed. Each matrix corresponds to one key process area, and each of the key process areas includes different goals for assessing implementation of the MSOC. Input from an assessor is received in each of the matrixes, and the input assesses the different goals of the key process areas of the MSOC implementation. Based on the input in each of the matrixes, a corresponding score is individually calculate for each of the key process areas of the MSOC, and each of the key process areas has its own corresponding score. Maturity levels are individually determined for each of the key process areas of the MSOC based on the corresponding score. The maturity levels are displayed for each of the key process areas.

### BACKGROUND

Exemplary embodiments relate to Management System and Operating Control (MSOC), and more particularly to, assessing the implementation of MSOC through the application of a Capability Maturity Model (CMM) tailored to complete a comprehensive assessment.

Organizations, such as businesses, utilize methodologies in attempt to streamline operations of the organization. Although a methodology may be put in place to improve an organization, managers may not always know the effectiveness of the methodology. Also, managers may not be sure whether the methodology has been implemented in a comprehensive and consistent manner across the organization.

### BRIEF SUMMARY

Exemplary embodiments include a method for assessing implementation of MSOC by an organization on a computer. Matrixes for key process areas of MSOC are displayed on the computer. Each of the matrixes corresponds to one of the key process areas, and each of the key process areas includes different goals for assessing implementation of MSOC. Input from an assessor is received in each of the matrixes, and the input assesses the different goals of the key process areas of MSOC implementation on the computer. Based on the input in each of the matrixes, a corresponding score is individually calculated for each of the key process areas of MSOC on the computer, and each of the key process areas has its own corresponding score. Maturity levels are individually determined for each of the key process areas of MSOC based on the corresponding score on the computer. The maturity levels are displayed for each of the key process areas on the computer.

Other systems, methods, apparatus, and/or computer program products according to embodiments will be or become apparent to one with skill in the art upon review of the following drawings and detailed description. It is intended that all such additional systems, methods, apparatus, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram of a computing device in accordance with exemplary embodiments;

FIG. 2 is a block diagram illustrating characteristics of maturity levels in accordance with exemplary embodiments;

FIG. 3 illustrates an example of a template for key process areas (KPAs) to be utilized in accordance with exemplary embodiments;

FIGS. 4-13 illustrate Management System and Operating Control (MSOC) Modules 1-10 of the key process areas in accordance with exemplary embodiments;

FIG. 14 illustrates an MSOC chart in accordance with exemplary embodiments;

FIG. 15 illustrates a process in accordance with exemplary embodiments; and

FIG. 16 illustrates a computer having elements utilized in exemplary embodiments.

The detailed description explains exemplary embodiments, together with features, by way of example with reference to the drawings.

### DETAILED DESCRIPTION OF EXEMPLARY EMBODIMENTS

Exemplary embodiments relate to Management System and Operating Control (MSOC) which is an operations management methodology provided by AT&T® but exemplary embodiments can be applied to other operations management methodologies.

Exemplary embodiments are configured to verify the effectiveness of management practices and the quality of the behaviors demonstrated by managers in operating environments where MSOC has been deployed. Exemplary embodiments are configured so that an MSOC assessor can determine if the functional organization is found to have successfully satisfied the operating criteria specified in the MSOC methodology. For reference, further information regarding MSOC can be found in U.S. Pat. No. 7,702,532 entitled “A Method, System And Storage Medium For Utilizing Training Roadmaps In A Call Center” filed on Dec. 12, 2003, which is incorporated by reference herein.

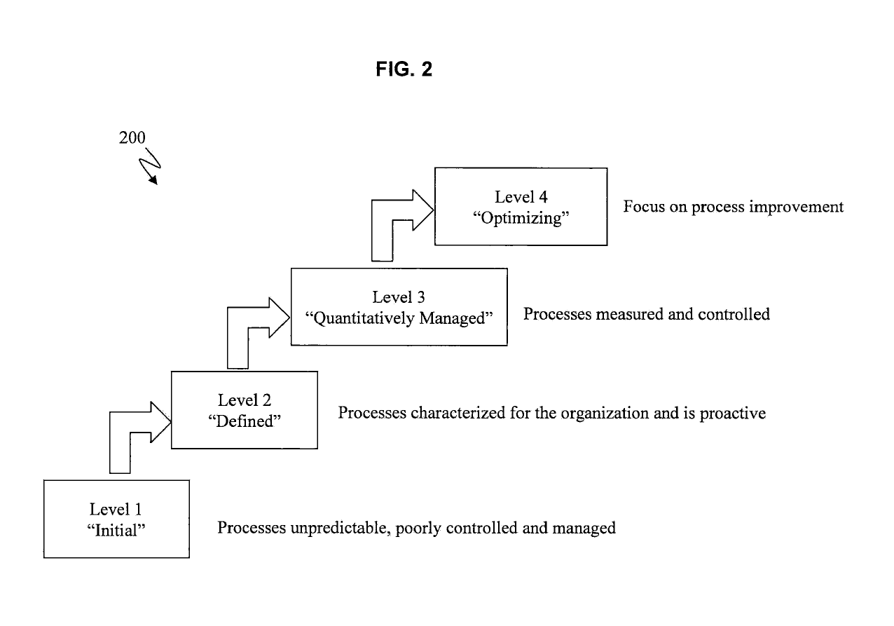

Exemplary embodiments implement a Capability Maturity Model (CMM) framework (as shown in FIG. 2) that allows for the assessment of the effectiveness of MSOC installations. The CMM is configured to address management of various disciplines of operations within the telecom industry, but is not limited to the telecom industry. Current application extends to numerous functional organizations within the industry, including but not limited to: technician call centers which provide technical support to field technicians, line field operations which include customer installation, maintenance, and construction technicians, customer information services which include switchboard operators, and consumer call centers such as, e.g., sales agents, but exemplary embodiments are not meant to be limited to such disciplines.

As discussed herein, the developed Capability Maturity Model (CMM) incorporates quantification criteria and qualification criteria from all key MSOC components. Regarding the MSOC CMM, functional organizations are assessed and assigned to one of four capability maturity levels. The MSOC CMM uses MSOC operating criteria as the foundation of the assessment questions to be answered during a CMM assessment but it is understood by one skilled in the art that the assessment is not limited to MSOC. The incorporation of core MSOC operational concepts into the MSOC CMM assessment criteria further defines the nature of this approach.

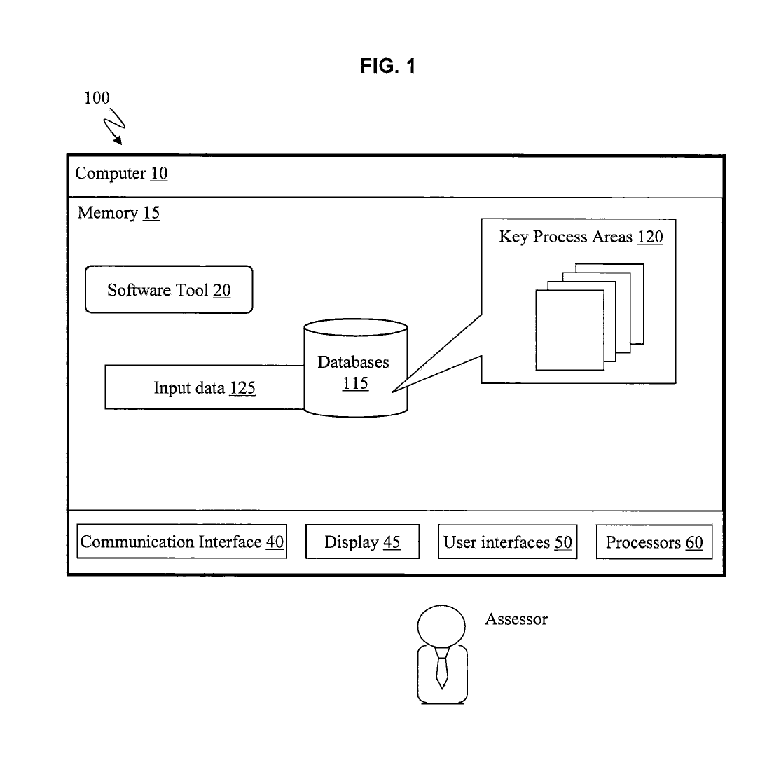

FIG. 1 illustrates a block diagram 100 in accordance with exemplary embodiments. The block diagram 100 illustrates an example system in which the MSOC CMM assessment may be implemented.

The diagram 100 depicts a computer 10 which may be one or more servers distributed over a network or operatively connected to one or more servers over a network. The computer 10 may include and/or be coupled to memory 15, a communication interface 40, display 45, user interfaces 50, processors 60, and software 20. The communication interface 40 comprises hardware and software for communicating over the network. The user interfaces 50 may include, e.g., a track ball, mouse, pointing device, keyboard, etc, for interacting with the computer 10, such as inputting information, making selections, typing text or numbers, etc. The processors 60 are for processing computer executable instructions of exemplary embodiments.

The computer 10 includes memory 15 which may be a computer readable storage medium. One or more software applications such as the software tool 20 may reside on or be coupled to the memory 15, and the software tool 20 comprises logic and software components to operate and function in accordance with exemplary embodiments in the form of computer executable instructions. The software tool 20 is configured to implement the MSOC CMM according to exemplary embodiments. The software tool 20 may include a graphical user interface (GUI) in which the MSOC assessor can interact with, e.g., to manually input data. The MSOC assessor is the user who utilizes the software tool 20 to assess the organization. Although the software tool 20 is shown as a single element in FIG. 1 for conciseness, the software tool 20 may represent numerous software components or modules according to exemplary embodiments. Additionally, any element of the computer 10 may be distributed across a network. The network may include circuit-switched and/or packet-switched technologies and devices, such as routers, switches, hubs, gateways, etc., for facilitating communications. The network may include IP networks. The network may include wireline and/or wireless components utilizing, e.g., IEEE 802.11 standards for providing over-the-air transmissions of communications.

The software tool 20 is configured to implement the Management System and Operating Control (MSOC) Capability Maturity Model (CMM) and the software tool 20 accomplishes four MSOC-related business objectives. The CMM of the software tool 20 ensures that MSOC's principles and guidelines are consistently implemented relative to each organization's operating environment; provides a standard methodology for assessing the degree to which MSOC has been implemented across all organizations; reinforces the relevancy and importance of MSOC; and institutionalizes MSOC's principles and methods. As mentioned above, the software tool 20 is utilized by an assessor who is the person and/or group tasked with assessing how well the MSOC is implemented by utilizing the CMM of the software tool 20. For example, the assessor may be a manager of the organization and/or may be from an external entity, such as AT&T®, who is contracted to perform the assessment of the organization. The software tool 20 is configured to provide guidance and display instructions to the assessor to help the assessor evaluate the organization. It is understood that the assessor is one who is familiar with MSOC such that the assessor is capable of evaluating the organization's implementation of MS OC.

MSOC CMM implemented by the software tool 20 ensures the assessor a consistent implementation of MSOC operational practices while recognizing meaningful distinctions in operating environments. For example, a particular element in any MSOC implementation is effective, daily communications between employees at all levels of the organization. In some organizations, however, there may be situations where daily, face-to-face communications between supervisors and employees is impractical. In situations where daily, face-to-face communications is impractical, the manager who may be the assessor is responsible for adopting alternative methods of communicating, such as daily conference calls. In this example, since the intent of MSOC to ensure daily communications with all employees is satisfied by using the alternative to face-to-face communications, MSOC CMM of the software tool 20 would imply or suggest to the assessor that the organization has an effective communications process relative to the situation.

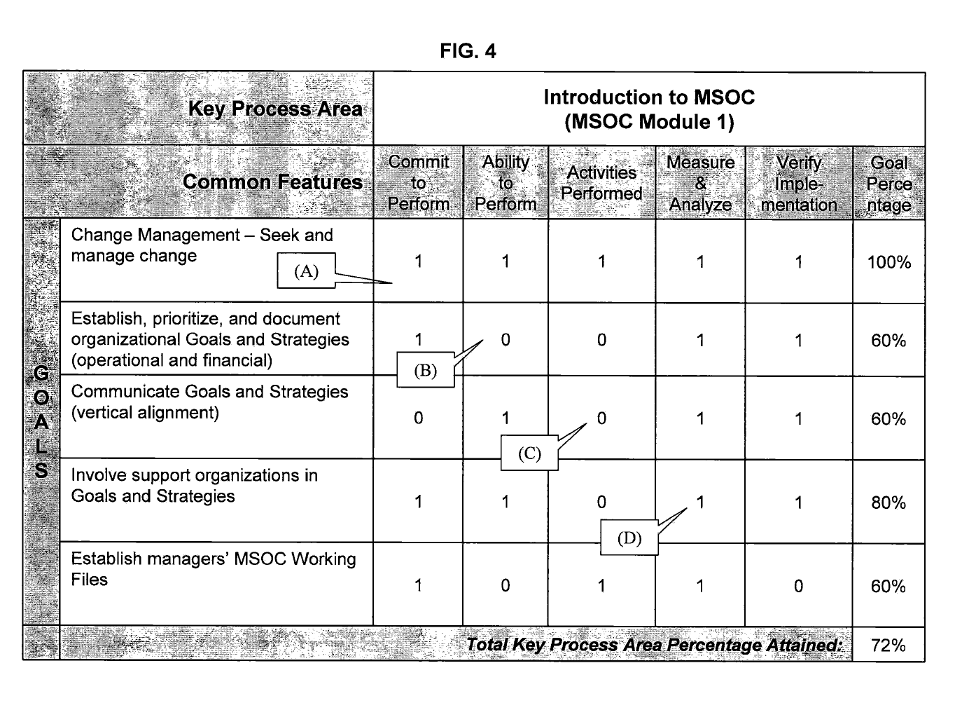

The MSOC CMM of the software tool 20 provides the assessor and the organization a standard criteria and methodology for assessing the degree to which MSOC is implemented and integrated. The criteria used to assess MSOC implementation and integration in the organization is provided in a series of ten process areas, discussed in FIGS. 4-13. The MSOC CMM of the software tool 20 addresses the implementation of MSOC operating methods and principles in a manner that may be adopted by any organization that has deployed MSOC.

FIG. 2 is a block diagram 200 that illustrates characteristics of maturity levels in accordance with exemplary embodiments. A maturity model is a structured collection of elements that describe areas of operational maturity within an organization, and exemplary embodiments can build upon this structure as will be understood by one skilled in the art. MSOC CMM of the software tool 20 is a framework that provides the assessor a method for continuously improving both operations management and the development of the employees in the organization. It describes an improvement path from ad hoc, inconsistently performed practices, to a mature, disciplined, and continuously improving operation. MSOC CMM focuses on the development of the knowledge, skills, and motivation of the workforce to enhance business performance. According to exemplary embodiments, the software tool 20 can determine which maturity level 1, 2, 3, and/or 4 that an organization is assessed to be in.

The MSOC CMM of the software tool 20 describes the “best practices” that constitute each of its maturity levels, and provides a method for assessing the organization's progress toward an optimum operating environment. The MSOC CMM of the software tool 20 provides a template for gauging workforce proficiency, assessing workforce practices, and planning activities for implementing improvements.

The MSOC CMM of the software tool 20 consists of four maturity levels 1, 2, 3, and 4 that establish successive foundations for: continuously improving both operational and employee competencies, developing effective teams, motivating improved performance, and shaping the workforce the organization needs to accomplish its future business plans. Each maturity level is a defined plateau that implements additional components used to further develop the organization's capabilities.

As seen in FIG. 2, the MSOC CMM model identifies four levels of process maturity for an organization from lowest to highest which include: Initial, also referred to as chaotic or ad hoc, is the starting point for use of a new process. Defined, also referred to as institutionalized, means that the process is defined/confirmed as a standard business process and is used repeatedly. Managed, also referred to as quantified, means that process management takes place. Optimizing, also referred to as process improvement, means that process management includes deliberate process optimization/improvement. These maturity levels are provided for explanation purposes and it is understood that fewer or more may be utilized.

At level 1 which is “ad hoc”, processes at this level are typically undocumented and in a state of dynamic change, tending to be driven in an ad hoc, uncontrolled and reactive manner by users or events. This provides a chaotic or unstable environment for the processes. The organizational implications of level 1 are: a) Institutional knowledge tends to be scattered having limited structured approach to knowledge management in such environments, not all of the stakeholders or participants in the processes may know or understand all of the components that make up the processes. As a result, process performance in such organizations is likely to be variable, e.g., inconsistent, and depend heavily on the institutional knowledge, individual competence, or the heroic efforts of relatively few people or small groups. b) Despite the chaos, such organizations manage to produce products and services. However, in doing so, there is significant risk that they will tend to exceed any estimated budgets or schedules for their projects; it is difficult to estimate what a process will do when the organization does not fully understand the process in the first place and cannot therefore control it or manage it effectively. c) Due to the lack of structure and formality, organizations at this level may over-commit, or abandon processes during a crisis, and it is unlikely that they will be able to repeat past successes. There tends to be limited planning, limited executive commitment or buy-in to projects, and limited acceptance of processes.

At level 2 which is “defined”, it is characteristic of processes at this level to have established sets of defined and documented standard processes that have been subject to some degree of improvement over time. These standard processes are in place, i.e., they are the as-is processes, and used to establish consistency of process performance across the organization. Organizational implications at level 2 are that process management starts to occur using defined documented processes, with mandatory process objectives, and ensures that these objectives are appropriately addressed.

At level 3 which is “quantitatively managed”, it is characteristic at this level that management can effectively control the as-is process, e.g., daily operations by using metrics indicative of performance within that organization. In particular, management can identify ways to adjust and adapt the process without measurable losses of quality or deviations from specifications. Process Capability is established from this level. Organizational implications include: quality goals will be established for their work output, and using quantitative/statistical techniques, process performance is measured and monitored, generally predictable, and controllable. Also at maturity level 3, processes are concerned with addressing statistical special causes of process variation and providing statistical predictability of the results, and though processes may produce predictable results, the results may still be insufficient to achieve desired objectives.

At level 4 which is “optimizing”, it is a characteristic of processes at this level to focus on continually improving process performance through both incremental and innovative improvements. Organizational implications include: a) Quantitative process-improvement objectives for the organization are established, continually revised to reflect changing business objectives, and used as criteria in managing process improvement. Process improvements are identified, evaluated, and deployed to address common causes of process variation. b) The effects of deployed process improvements are measured and evaluated against the quantitative process-improvement objectives. c) Both the defined processes and the organization's set of standard processes are targets for measurable improvement activities. d) The organization's work force has an established predictive methodology to forecast both short-term and long-term work volumes and required resources. Also, at maturity level 4, processes are concerned with addressing statistical common causes of process variation and changing the process, e.g., shifting the mean of the process duration, to improve performance. This would be done at the same time as maintaining the likelihood of achieving the established quantitative process-improvement objectives.

With reference to FIG. 1, the computer 10 includes key process areas (KPA) 120 stored in, e.g., a database 115. The key process areas 120 are evaluation forms configured as matrixes of the software tool 20 to be filled in by the assessor with data input by the assessor. The data input by the assessor may generally be referred to as input data 125. The software tool 20 displays the key process areas 120 to the assessor on the display 45, and the assessor can utilize the user interface 50 to fill in input data 125 into the evaluation forms. In exemplary embodiments, 10 key process areas 120 are presented to the assessor for the MSOC CMM and a separate evaluation form corresponds to each key process area 120, but it is understood that more or fewer key process areas 120 may be evaluated if desired. When the software tool 20 receives the input data 125 for each key process area 120, the software tool 20 determines a total score for each individual key process area 120 and displays the score to the assessor on the display 45. Also, based on the calculated total score from the evaluation form for the particular key process area 120, the software tool 20 determines if that particular key process area 120 falls in level 1, level 2, level 3, and/or level 4. For example, if the total score, i.e., total key process area percentage attained, for a key process area 120 is between 90-100%, the software tool 20 determines that this key process area 120 is in level 4. If the total score for a key process area 120 is between 80-89%, the software tool 20 determines that this key process area 120 is in level 3. If the total score for a key process area 120 is between 70-79%, the software tool 20 determines that this key process area 120 is in level 2. If the total score for a key process area 120 is 69% or below, the software tool 20 determines that this key process area 120 is in level 1. These determinations of levels 1, 2, 3, and 4 by the software tool 20 are flexible and can be modified as needed. For example, each of the levels could be increased by 1%, 2%, 3%, and/or 5% depending on preference, and/or each of the levels could be decreased by 1%, 2%, 3%, and/or 5% depending on preference. To achieve an overall Level 2 capability maturity when considering all ten MSOC Modules as a whole, the organization would require a score of at least 90% in each of MSOC Modules 1, 2, and 3. Similarly, to achieve an overall Level 3 capability maturity, the organization would have to achieve at minimum a 90% score in MSOC Modules 1 thorough 8, inclusively. An overall Level 4 capability maturity is achieved when the organization achieves at least a 90% proficiency level in each of the MSOC Modules which are MSOC Module 1 through MSOC Module 10.

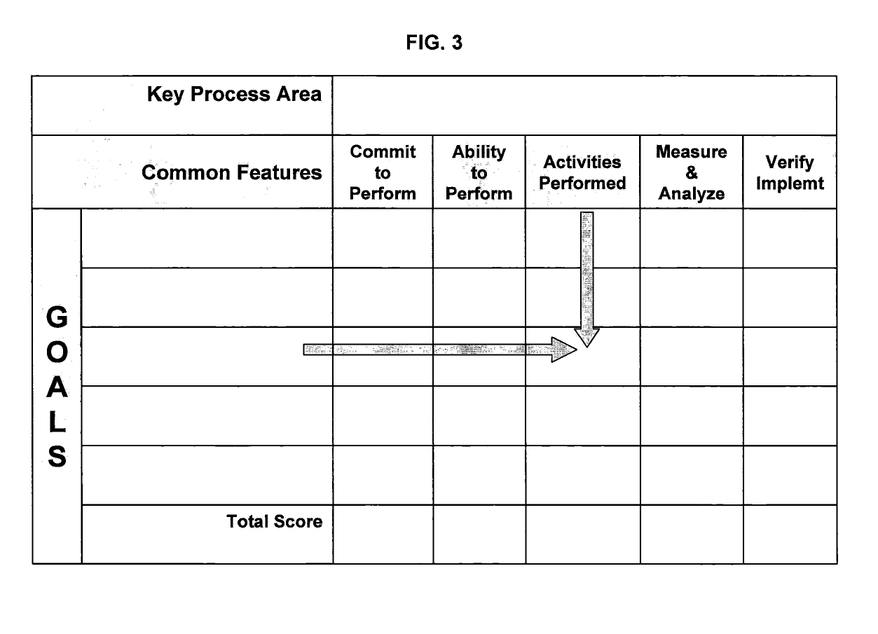

FIG. 3 illustrates an example of a template for key process areas (KPAs) 120 to be utilized in accordance with exemplary embodiments. The MSOC CMM defines MSOC Modules 1-10 as the key process areas (KPAs) 120. The evaluation forms for the Modules 1-10 are illustrated in FIGS. 4-13 and are displayed to the assessor via the software tool 20. The 10 KPAs 120 include related activities that are performed collectively to achieve a set of goals that may be considered central in evaluating the organization's implementation of MSOC. For each KPA there are two components identified, which are goals and common features.

As described in exemplary embodiments, each KPA 120 has four (4) to seven (7) goals. The maturity level, e.g., shown in FIG. 2, to which each goal has been achieved is determined by the degree to which the organization has executed operating practices with respect to the related common features. When assessing the organization via the software tool 20, goals are the descriptions of the state that should exist for an effective and lasting implementation of MSOC, and the extent to which the goals have been accomplished is an indicator of how much capability the organization has established at that maturity level; the goals signify the scope, boundaries, and intent of each MSOC key process area.

The common features are “engagement” descriptors of MSOC behavioral and mechanical components. Common features are used by the assessor via software tool 20 to gauge how effectively the organization has implemented and institutionalized each key process area. Common features are general descriptors that when considered as a whole comprise a balanced view of the current level of employee and organizational engagement. There are five types of common features evaluated by the assessor via the software tool 20, which are illustrated below:

Commitment to Perform: Are the employees committed to perform the key process area under consideration? Is there alignment and understanding of the goals at all levels of the organization? Are all employees focused on achieving the goals?

Ability to Perform: Do all employees demonstrate an ability to perform within the key process area under consideration? Have employees at all levels been trained and are appropriate systems in place to progressively advance toward the goal?

Activities Performed: Are appropriate activities being performed related to the key process area under consideration? Is there evidence that employees at all levels of the organization have engaged and taken steps to participate in achieving the goal?

Measurement and Analysis: Are there metrics in place to demonstrate that the organization monitors all aspects of operations to improve performance? This common feature is not intended to be limited to the performance metrics used by the organization to gauge employee performance. It should include any metric used to measure performance of any component of daily operations within the organization.

Verifying Implementation: Do data records and other documentation confirm efforts have been put forth at appropriate levels of the organization to progress toward specified goals?

The software tool 20 may automatically display to the assessor the above questions of the common features for each of the KPA MSOC Modules 1-10 on the display 45 as the assessor progresses through each Module.

When assessing MSOC capability maturity of the organization via the software tool 20, the software tool 20 displays the CMM Matrix which is the evaluation form to assess capability maturity as will be seen further in FIGS. 4-13 and the software tool 20 requires that assessor review each of the goals specified in the “Goals” section against the five common features described above.

For the evaluation form, the default value set by the software tool 20 for each scoring opportunity in the matrix is zero (0). Utilizing the software tool 20, the zero is replaced with a one (1) when the capability has been achieved. In some implementations, there may not be a default value set by the software tool 20, and the assessor can input ones (1) and zeros (0) in the software tool 20.

If the assessor reviews a specified goal and determines that the common feature has been achieved, a score of one (1) is assigned in the software tool 20 by the assessor; otherwise, the score remains zero (0). In the software tool 20, the highest achievable score for any MSOC CMM specified goal is five (5) when adding the scores horizontally. In FIGS. 4-13, the 10 KPAs are shown with a total percentage for each goal. The highest achievable score for any MSOC CMM matrix section is five (5) times the total number of goals specified as calculated by the software tool 20 based on the input data 125, which are the ones (1) and zeroes (0) input by the assessor. In some implementations, full capability is not achieved until an organization has established at least 90% of the common features for the goals specified under each key process area 120.

Now turning to the 10 MSOC CMM key process area matrices 120 in more detail, FIG. 4 illustrates “Introduction to MSOC” which is MSOC Module 1 of the key process areas 120 in accordance with exemplary embodiments. When viewing the display 45, the software tool 20 displays Module 1 of the KPA 120 to the assessor to receive input data 125, and the software tool 20 may display part and/or all the following instructions to assist the assessor: “When assessing this Module 1 of the capability maturity, you should look for evidence of both vertical alignment and horizontal alignment; vertical alignment ensures that the business goals and strategies are aligned at every level of management, from the represented employee to the Chief Executive Officer; horizontal alignment ensures that first level supervisors and their subordinates have the tools required to deliver the desired outcome; you should seek tangible evidence that both vertical and horizontal alignment have been achieved, that the required mechanical components are in place, e.g., such as ‘Achievement & Development Forms’, and that MSOC behaviors such as actively seeking improvement opportunities are demonstrated.”

For the key process area “Introduction to MSOC” of MSOC Module 1, the software tool 20 can display instructions on the display 45 that ask the assessor to include, e.g., at a minimum, the following components when completing the assessment: “1) Ensure all employees are aligned on the goals and strategies of the organization and focused on fostering an environment that encourages positive change. 2) Confirm that employees at all levels have the tools and knowledge necessary to support the strategies required to meet all objectives. 3) Seek out evidence that employees at all levels of the organization and the organizations that support your effort are engaged in achieving the goals specified. 4) Verify that performance metrics are in place and that the tools are designed to encourage progress toward the organization's goals by following specified strategies. 5) Review MSOC working files at all levels of the organization to ensure that appropriate effort is put forth to achieve the specified goals.”

In FIG. 4, the “Introduction to MSOC” Module 1 of the key process areas 120 was displayed to the assessor via a GUI of the software tool 20. The assessor has evaluated the organization and input ones (1) and zeros (0) as the input data 125 into the matrix by using the user interface 50. As noted above, the matrix of the key process areas 120 may have zeros (0) in each cell by default, and the assessor can change the zeros (0) to ones (1) if that goal is met for the particular common feature. The additional Modules 2-10 have input data 125 as well for explanation purposes.

Referring back to FIG. 4, the software tool 20 receives the input data 125 for each goal, e.g., which are 5 goals in “Introduction to MSOC” Module 1, that coincides to each of the common features. In the “Introduction to MSOC” Module 1, the software tool 20 calculates a goal percentage for each one (1) input to corresponds with the 5 columns of the common features, and the first goal which is change management—seek and manage change is calculated (5×20%) by the software tool 20 to have a row goal percentage of 100%. Since there are 5 columns, each one (1) in the first goal of the first row equals 20%. The second goal is establish, prioritize, and document organizational goals and strategies. For the second goal in the second row of the matrix, there are 3 ones (1) input by the assessor. Accordingly, the software tool 20 multiplies the number of cells with a one (1) for the second goal times 20% to equal a row goal percentage of 60% (3×20%), and continues to the next goal. The software tool 20 calculates a goal percentage for each of the goals, e.g., which are 5 in Module 1, to determine a goal percentage for each goal. Also, the software tool 20 calculates the total key process area percentage attained as 72% by adding the row goal percentages, e.g., such as adding 100%+60%+60%+80%+60%, together for each goal and then dividing by the total number of goals (rows) in the particular Module, which is 5 in Module 1. Based on the calculated total key process area percentage attained (72%) for “Introduction to MSOC” Module 1, the software tool 20 determines which of the four levels that this evaluated key process area 120 is assigned. In this example, the software tool 20 determines that the KPA 120 for “Introduction to MSOC” Module 1 is assigned to CMM level 2.

Further as the assessor is evaluating the organization using the displayed matrix of the KPA 120, the assessor can utilize the user interface 50 to select a cell in the matrix of the software tool 20, e.g., by moving the cursor over the cell, by highlighting the cell, and/or clicking on the cell. One skilled in the art understands that the matrix has rows and columns which intersect to form individual cells. When the assessor selects a cell in the matrix of the KPA 120, the software tool 20 displays further hints and/or instructions related to the, e.g., highlighted cell. In certain cells of the key process areas 120, letters have been included for explanation purposes to represent that the assessor has selected the particular cell for the software tool 20 to display further information to the assessor. Although example cells are shown with letters representing that the assessor has highlighted these cells, the software tool 20 is configured to display further instructions to the assessor for each cell. When the assessor highlights the corresponding cell represented as letter (A), the software tool 20 displays to the assessor: “If all employees are aligned on the goals and strategies of the organization and are focused on fostering an environment that encourages positive change, assign a score of one (1). If not, the score should remain at zero (0).” When the assessor highlights the corresponding cell represented as letter (B), the software tool 20 displays to the assessor: “If the employees at all levels of the organization have been trained and appropriate systems are in place to establish, prioritize, and document the operational and financial goals of the organization, assign a score of one (1). If not, the score should remain at zero (0).” When the assessor highlights the corresponding cell represented as letter (C), the software tool 20 displays to the assessor: “If there is evidence that employees at all levels of the organization have taken steps to communicate the goals and the strategies that will be used to achieve them, assign a score of one (1). If not, the score should remain at zero (0).” When the assessor highlights the corresponding cell represented as letter (D), the software tool 20 displays to the assessor: “If there is evidence that employees within adjunct support organizations have metrics and analytical processes in place that facilitate your organization's achievement of the specified goals, assign a score of one (1). If not, the score should remain at zero (0).” Although a few cells have been identified for the sake of brevity and illustration purposes, it is understood that hints and instructions are displayed by the software tool 20 to the assessor for each cell according to exemplary embodiments

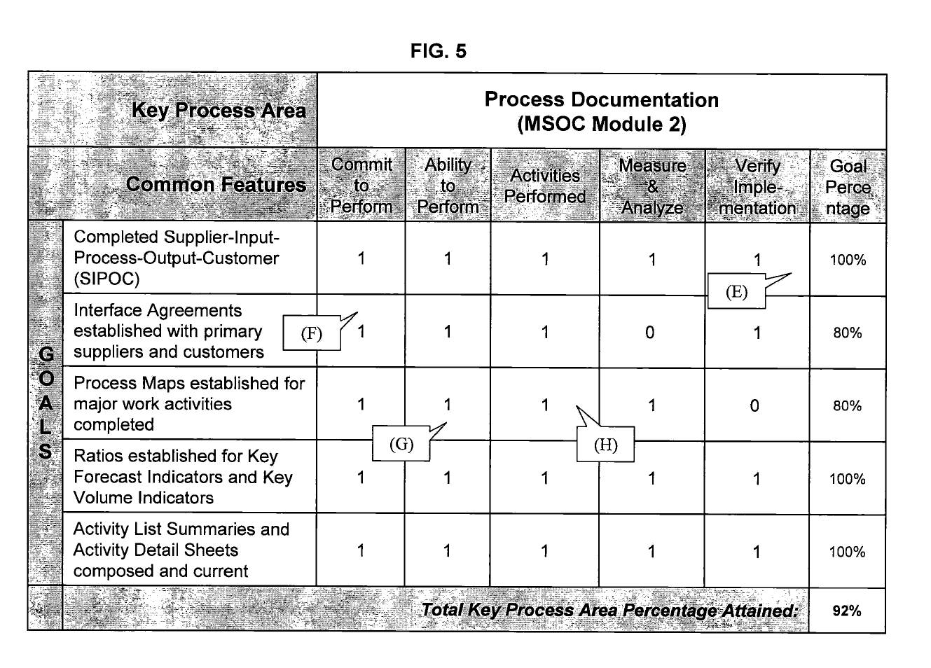

FIG. 5 illustrates “Process Documentation” which is MSOC Module 2 of the key process areas 120 in accordance with exemplary embodiments. When viewing the display 45, the software tool 20 displays Module 2 of the KPA 120 to the assessor to receive input data 125, and the software tool 20 may display part and/or all the following instructions to assist the assessor: “When assessing this Module 2 of the area of capability maturity, you should confirm that the required mechanical components are in place, actively monitored, and kept aligned with the organization's current methodology; you should seek tangible evidence that supplier input process output customer (SIPOCs), Interface Agreements, Process Maps and related process documentation are readily attainable, kept up-to-date, and available to all employees.”

For the key process area “Process Documentation” of MSOC Module 2, the software tool 20 is configured to display instructions on the display 45 that ask the assessor to include, e.g., at a minimum the following components when completing your assessment: “1) Ensure all employees are aware of the various process documentation components, understand underlying purposes for each component, and are committed to appropriate application: a) management employees should have a deep understanding of all process documentation components, e.g., SIPOCs, Interface Agreements, etc., in terms of both the content and purpose of each and; b) occupational non-management employees should understand the general business purpose of the SIPOCs and Interface Agreements, and have an understanding of the Process Maps, Activity List Summaries, and Activity Detail Sheets. 2) Confirm that employees at all levels have the tools and knowledge necessary to effectively apply components to daily work activities in support of meeting objectives. 3) Seek out evidence that employees at all levels of the organization and the organizations that support your efforts are aware of available documentation and can effectively apply the components to improve daily operations. 4) Verify that metrics and analytical methods are in place to ensure documentation is kept current and changes are incorporated into existing documentation in a timely manner. 5) Review MSOC working files at all levels of the organization to ensure that documentation is current, comprehensive, and accessible to all employees.”

In this scenario of FIG. 5, the “Process Documentation” Module 2 of the key process areas 120 is displayed to the assessor via a GUI of the software tool 20. The assessor has evaluated the organization and input ones (1) and zeros (0) as the input data 125 into the matrix by using the user interface 50. As discussed above, the software tool 20 calculates row goal percentages for each of the goals, and determines a total key process area percentage attained as 92% for the evaluated Module 2. Based on the calculated total key process area percentage attained (92%) for “Process Documentation” Module 2, the software tool 20 determines which of the four levels that this evaluated key process area 120 is assigned. In this example, the software tool 20 determines that the KPA 120 for “Process Documentation” Module 2 is assigned to CMM level 4.

Further as the assessor is evaluating the organization using the displayed matrix of the KPA 120, the assessor can utilize the user interface 50 to select a cell in the matrix of the software tool 20 on the display 45, e.g., by moving the cursor over the cell, by highlighting the cell, and/or clicking on the cell. When the assessor highlights the corresponding cell represented as letter (E), the software tool 20 displays to the assessor: “If there is evidence that process documentation is capturing performance criteria and a program is in place to ensure performance standards are achieved, assign a score of one (1). If not, the score should remain at zero (0).” When the assessor highlights the corresponding cell represented as letter (F), the software tool 20 displays to the assessor: “If the employees at all levels of the organization are aware of the various process documentation components, understand underlying purposes for each component, and are committed to appropriate application, assign a score of one (1). If not, the score should remain at zero (0)”. When the assessor highlights the corresponding cell represented as letter (G), the software tool 20 displays to the assessor: “If there is evidence that employees at all levels have been trained and appropriate systems are in place to progressively advance toward organizational goals, assign a score of one (1). If not, the score should remain at zero (0)”. When the assessor highlights the corresponding cell represented as letter (H), the software tool 20 displays to the assessor: “If there is evidence that employees at all levels of the organization can locate and effectively apply the various form of MSOC documentation, assign a score of one (1). If not, the score should remain at zero (0)”.

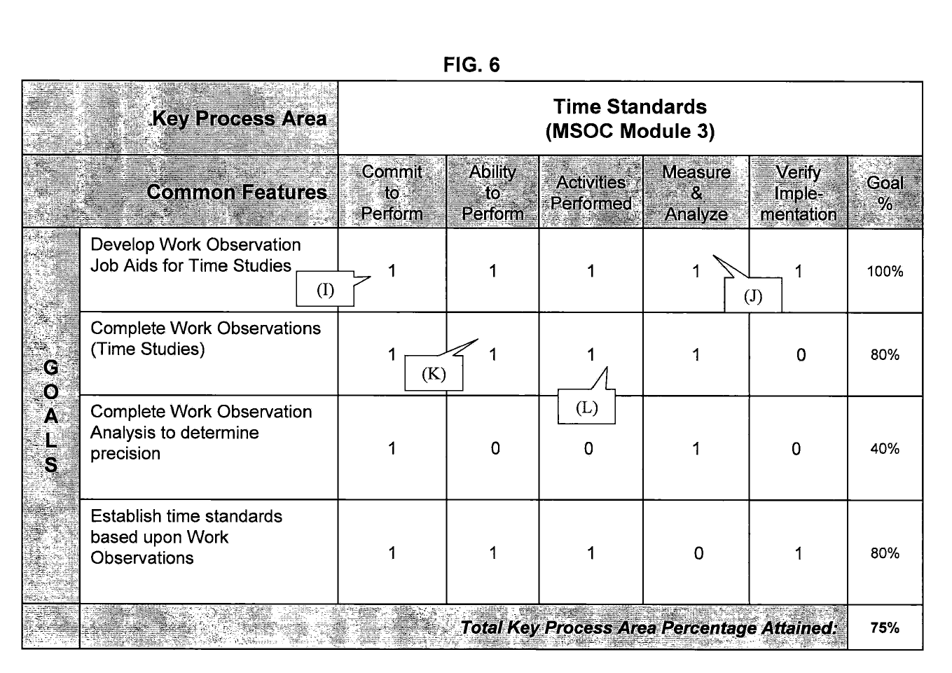

FIG. 6 illustrates “Time Standards” which is MSOC Module 3 of the key process areas 120 in accordance with exemplary embodiments. When viewing the display 45, the software tool 20 displays Module 3 of the KPA 120 to the assessor to receive input data 125, and the software tool 20 may display part and/or all the following instructions to assist the assessor: “When assessing this Module 3 of the area of capability maturity, you should review the current state of time standards and determine the manager's knowledge of how the time standards relate to work performance; you should also confirm that the time standards have been developed sufficiently to provide effective metrics for managing operations within the organization under review.”

For the key process area “Time Standards” of MSOC Module 2, the software tool 20 is configured to display instructions on the display 45 that ask the assessor to include, e.g., at a minimum, the following components when completing your assessment: “1) Ensure the organization has formulated a plan for the development of time standards, either using internal or external resources to complete the work. 2) Confirm that the organization has the data collection tools and work registration systems in place to construct valid time standards and effectively credit time to employees. 3) Seek out evidence that employees at all levels of the organization and the organizations that support your efforts understand the application of time standards and can effectively apply the components to improve daily operations. 4) Verify that metrics and analytical methods are in place to ensure the time standards are used in an effective manner to gauge performance. 5) Review MSOC working files at all levels of the organization to ensure that efforts have been undertaken to ensure time standards are kept current, comprehensive and accessible to all employees.”

In FIG. 6, the “Time Standards” Module 3 of the key process areas 120 is displayed to the assessor via a GUI of the software tool 20, and the assessor inputs ones (1) and zeros (0) as the input data 125 into the matrix by using the user interface 50. As discussed above, the software tool 20 calculates row goal percentages for each of the goals, and determines a total key process area percentage attained of 75% for the evaluated Module 3. Based on the calculated total key process area percentage attained (75%) for “Time Standards” Module 3, the software tool 20 determines which of the four levels that this evaluated key process area 120 is assigned. In this example, the software tool 20 determines that the KPA 120 for “Time Standards” Module 3 is assigned to CMM level 2.

Further as the assessor is evaluating the organization using the displayed matrix of the KPA 120, the assessor can utilize the user interface 50 to select a cell, e.g., by moving the cursor over the cell, by highlighting the cell, and/or clicking on the cell, in the matrix of the software tool 20 on the display 45. When the assessor highlights the corresponding cell represented as letter (I), the software tool 20 displays to the assessor: “If the employees at all levels of the organization are familiar with the time standards and understand their application in a continuous improvement operating environment, assign a score of one (1). If not, the score should remain at zero (0).” When the assessor highlights the corresponding cell represented as letter (J), the software tool 20 displays to the assessor: “If there is evidence that time standards are used in a program designed to foster a continuous improvement environment and a comprehensive set of metrics based on the time standards is established, assign a score of one (1). If not, the score should remain at zero (0).” When the assessor highlights the corresponding cell represented as letter (K), the software tool 20 displays to the assessor: “If there is evidence that employees are effectively applying time standards in the management of daily operations, assign a score of one (1). If not, the score should remain at zero (0).” When the assessor highlights the corresponding cell represented as letter (L), the software tool 20 displays to the assessor: “If there is evidence that employees at all levels of the organization can demonstrate understanding of time standards by providing evidence of use in daily operations, assign a score of one (1). If not, the score should remain at zero (0)”.

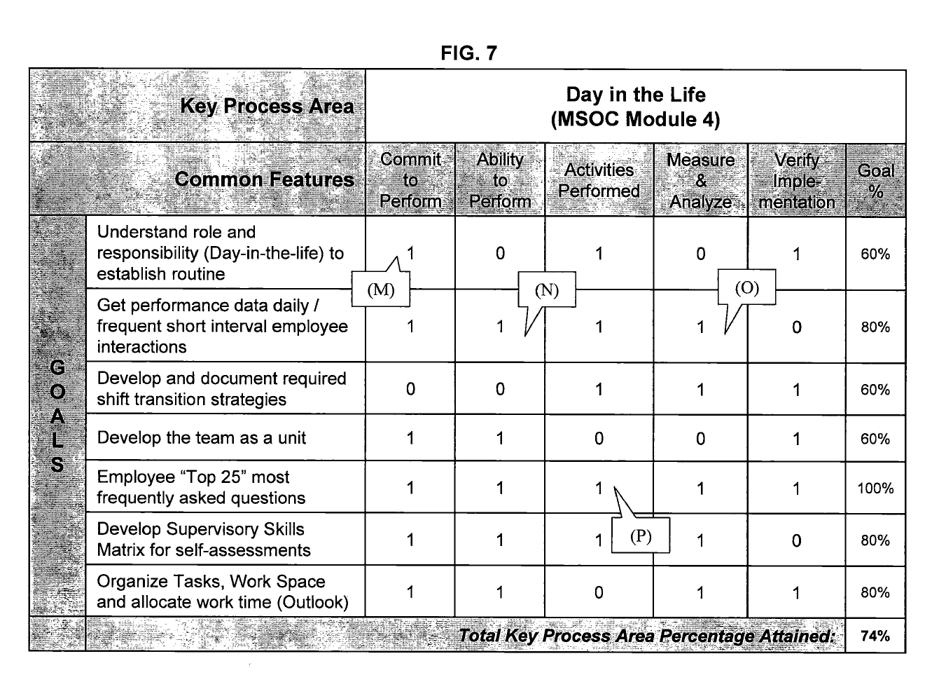

FIG. 7 illustrates “Day in the Life—Establishing A Routine” which is MSOC Module 4 of the key process areas 120 in accordance with exemplary embodiments. When viewing the display 45, the software tool 20 displays Module 4 of the KPA 120 to the assessor to receive input data 125, and the software tool 20 may display part and/or all the following instructions to assist the assessor: “When assessing this Module 4 of the area of capability maturity, you should seek out evidence that the manager is actively reviewing performance results and taking appropriate action to improve operations; in order to maximize effectiveness, the manager should be well organized and be able to demonstrate a well defined routine for managing daily operations.”

For the key process area “Day in the Life” of MSOC Module 4, the software tool 20 is configured to display instructions on the display 45 that ask the assessor to include, e.g., at a minimum, the following components when completing your assessment: “1) Ensure the organization has formulated a plan to establish a daily routine that optimizes the first level manager's time. 2) Confirm that the organization has the data collection tools and work registration systems in place to provide daily performance feedback to employees. 3) Verify that some form of shift transition strategy is in place, and that employees understand how to convey issues to upcoming work shifts. 4) Seek out evidence that effort has been put forth to develop the employees to work as a team. 5) Ensure that level 2 managers are actively engaged in the development of their level 1 management subordinates. 6) Verify elements of a ‘Continuous Improvement’ working environment, including dialogues at the start of the work shift, consistent recurring establishment of action items, and execution of Action Plans. 7) Determine what components are in place to develop supervisory skills and what program has been established to ensure ongoing development. 8) Observe office work locations to gauge the level of organization demonstrated by the manager.”

In FIG. 7, the “Day in the Life” Module 4 of the key process areas 120 is displayed to the assessor via a GUI of the software tool 20, and the assessor inputs ones (1) and zeros (0) as the input data 125 into the matrix by using the user interface 50. As discussed above, the software tool 20 calculates row goal percentages for each of the goals, and determines a total key process area percentage attained of 74% for the evaluated Module 4. Based on the calculated total key process area percentage attained (74%) for “Day in the Life” Module 4, the software tool 20 determines which of the four levels that this evaluated key process area 120 is assigned. In this example, the software tool 20 determines that the KPA 120 for “Day in the Life” Module 4 is assigned to CMM level 2.

Further as the assessor is evaluating the organization using the displayed matrix of the KPA 120, the assessor can utilize the user interface 50 to select a cell, e.g., by moving the cursor over the cell, by highlighting the cell, and/or clicking on the cell, in the matrix of the software tool 20 on the display 45. When the assessor highlights the corresponding cell represented as letter (M), the software tool 20 displays to the assessor: “If the employees at all levels of the organization are familiar with their roles and responsibilities regarding a daily routine, assign a score of one (1). If not, the score should remain at zero (0).” When the assessor highlights the corresponding cell represented as letter (N), the software tool 20 displays to the assessor: “If there is evidence that there are systems in place to effectively monitor employee performance on a daily basis, assign a score of one (1). If not, the score should remain at zero (0)”. When the assessor highlights the corresponding cell represented as letter (O), the software tool 20 displays to the assessor: “If there is evidence that reports are generated on a daily basis and are effectively analyzed to identify opportunities for improving operations, assign a score of one (1). If not, the score should remain at zero (0)”. When the assessor highlights the corresponding cell represented as letter (P), the software tool 20 displays to the assessor: “If there is evidence that employees at all levels of the organization are engaged in improving performance through daily dialogues, creation of action items/action plans for removal of performance obstacles, etc., assign a score of one (1). If not, the score should remain at zero (0)”.

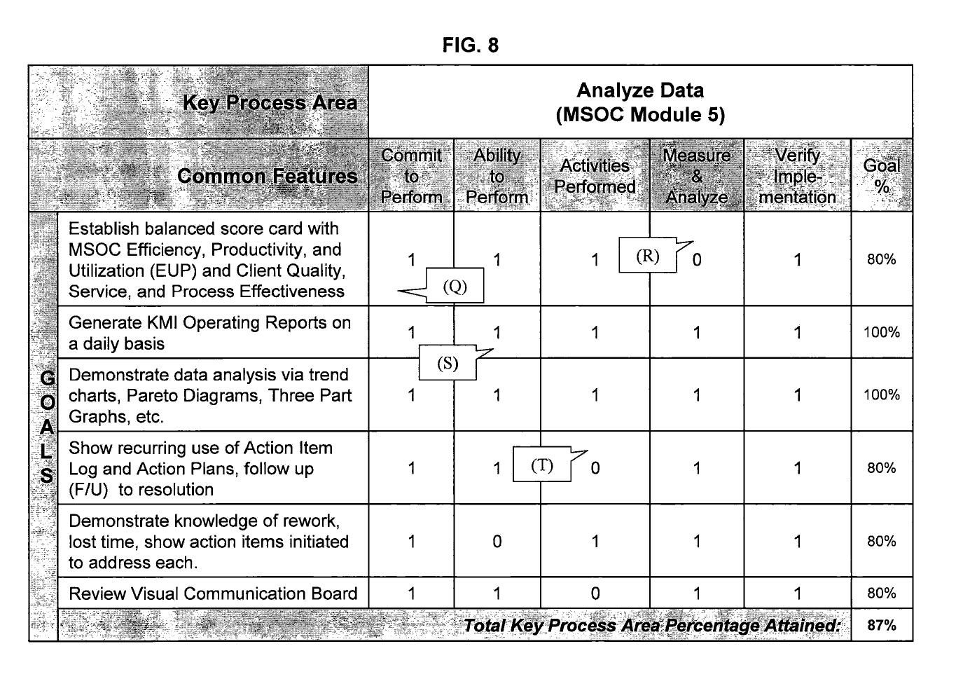

FIG. 8 illustrates “Analyze Data” which is MSOC Module 5 of the key process areas 120 in accordance with exemplary embodiments. When viewing the display 45, the software tool 20 displays Module 5 of the KPA 120 to the assessor to receive input data 125, and the software tool 20 may display part and/or all the following instructions to assist the assessor: “When assessing this Module 5 of the area of capability maturity, you should seek to identify proficiency in the areas of trending results, analyzing results, and taking appropriate actions.”

For the key process area “Analyze Data” of MSOC Module 5, the software tool 20 is configured to display instructions on the display 45 that ask the assessor to include, e.g., at a minimum, the following components when completing your assessment: “1) Ensure that systems are in place to generate a balanced score card, that the organization has been trained, and that there is an effective program in place to complete analysis. 2) Confirm that key measurement indicator (KMI) Operating Reports are generated on a daily basis, that results are analyzed, and that performance data is shared at all levels of the organization. 3) Review trend charts, Pareto diagrams, histograms, etc. to determine if appropriate action is taken when data indicate opportunities for improvement. 4) Verify that Action Items are generated on a continual and recurring basis and review Action Items for Action Plans, review Action Plans for timely completion. 5) Review Quality metrics to determine if rework opportunities are addressed by the organization. 6) Determine if actions are taken to eliminate and/or reduce lost time events. 7) Confirm that the Visual Communications Board is current and has been updated with regularity.”

In FIG. 8, the “Analyze Data” Module 5 of the key process areas 120 is displayed to the assessor via a GUI of the software tool 20, and the assessor inputs ones (1) and zeros (0) as the input data 125 into the matrix by using the user interface 50. As discussed above, the software tool 20 calculates row goal percentages for each of the goals, and determines a total key process area percentage attained of 87% for the evaluated Module 5. Based on the calculated total key process area percentage attained (87%) for “Analyze Data” Module 5, the software tool 20 determines which of the four levels that this evaluated key process area 120 is assigned. In this example, the software tool 20 determines that the KPA 120 for “Analyze Data” Module 5 is assigned to CMM level 3.

Further as the assessor is evaluating the organization using the displayed matrix of the KPA 120, the assessor can utilize the user interface 50 to select a cell, e.g., by moving the cursor over the cell, by highlighting the cell, and/or clicking on the cell, in the matrix of the software tool 20 on the display 45. When the assessor highlights the corresponding cell represented as letter (Q), the software tool 20 displays to the assessor: “If the supervisors and subordinates are actively engaging in performance related dialogue, assign a score of one (1). If not, the score should remain at zero (0).” When the assessor highlights the corresponding cell represented as letter (R), the software tool 20 displays to the assessor: “If there is evidence that reports are generated on a daily basis and are effectively analyzed to identify opportunities for improving operations, assign a score of one (1). If not, the score should remain at zero (0)”. When the assessor highlights the corresponding cell represented as letter (S), the software tool 20 displays to the assessor: “If there is evidence that there are systems in place to effectively generate employee performance on a daily basis, assign a score of one (1). If not, the score should remain at zero (0)”. When the assessor highlights the corresponding cell represented as letter (T), the software tool 20 displays to the assessor: “If there is evidence that employees at all levels of the organization are engaged in improving performance through daily dialogues, creation of action items/action plans for removal of performance obstacles, etc., assign a score of one (1). If not, the score should remain at zero (0)”.

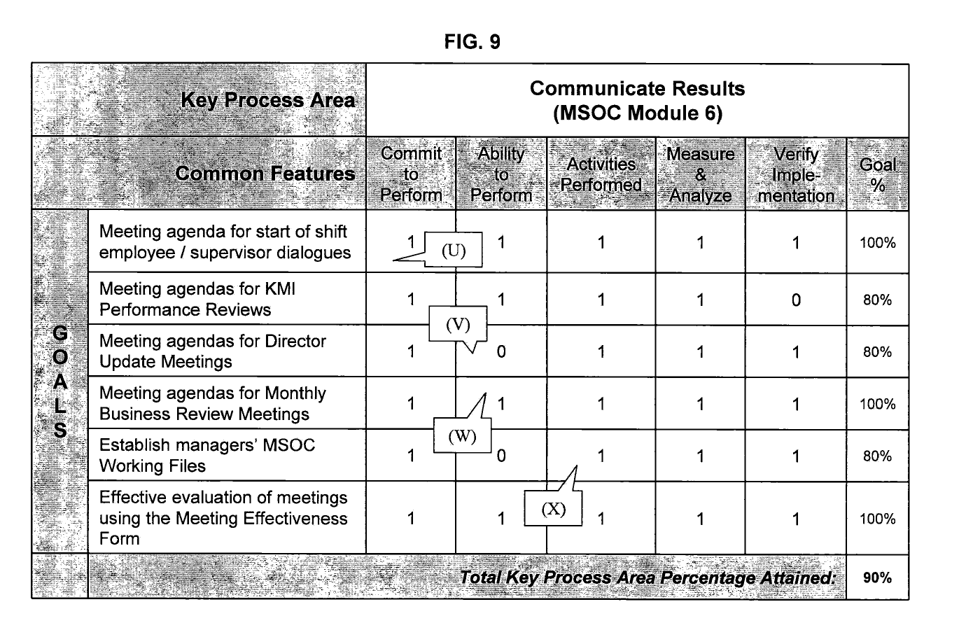

FIG. 9 illustrates “Communicate Results” which is MSOC Module 6 of the key process areas 120 in accordance with exemplary embodiments. When viewing the display 45, the software tool 20 displays Module 6 of the KPA 120 to the assessor to receive input data 125, and the software tool 20 may display part and/or all the following instructions to assist the assessor: “When addressing this area of capability maturity, you should look for effective two-way dialogues between the supervisor and the subordinates; while communicating at the beginning of the shift is important, also look for and assess exchanges between the Supervisor and subordinates throughout the day.”

For the key process area “Communicate Results” of MSOC Module 6, the software tool 20 is configured to display instructions on the display 45 that ask the assessor to include, e.g., at a minimum, the following components when completing your assessment: “1) Ensure that the Manager routinely prepares and effectively uses meeting agendas for the start of shift employee/supervisor dialogues. 2) Confirm that KMI Performance Reviews are conducted on a routine and recurring basis and that during the meeting performance issues are identified and addressed. 3) Confirm that Director Update Meetings are conducted on a routine and recurring basis and that during the meeting performance issues are identified and addressed. 4) Verify that Monthly Business Review Meetings are conducted on a routine and recurring basis and that during the meeting performance issues are identified and addressed. 5) Review the Managers MSOC working files for content and comprehension and ensure all required files are in place and current. 6) Determine the extent to which Meeting Effectiveness reviews have been performed and observe one or more meeting to gauge the effectiveness of the organizer.”

In FIG. 9, the assessor via a GUI of the software tool 20 inputs ones (1) and zeros (0) as the input data 125 into the matrix by using the user interface 50. As discussed above, the software tool 20 calculates row goal percentages for each of the goals, and determines a total key process area percentage attained of 90% for the evaluated Module 6. Based on the calculated total key process area percentage attained (90%) for “Communicate Results” Module 6, the software tool 20 determines which of the four levels that this evaluated key process area 120 is assigned. In this example, the software tool 20 determines that the KPA 120 for “Communicate Results” Module 6 is assigned to CMM level 4 and displays the CMM level to the assessor.

Further as the assessor is evaluating the organization using the displayed matrix of the KPA 120, the assessor can utilize the user interface 50 to select a cell in the matrix of the software tool 20 on the display 45. When the assessor highlights the corresponding cell represented as letter (U), the software tool 20 displays to the assessor: “If the supervisors and subordinates are actively engaging in performance related dialogue, assign a score of one (1). If not, the score should remain at zero (0)”. When the assessor highlights the corresponding cell represented as letter (V), the software tool 20 displays to the assessor: “If there is evidence that there are systems in place to ensure Director Updates occur on a weekly basis, assign a score of one (1). If not, the score should remain at zero (0)”. When the assessor highlights the corresponding cell represented as letter (W), the software tool 20 displays to the assessor: “If there is evidence that reports are generated and are effectively analyzed to identify opportunities for improving operations, and that all levels of management are engaged in the resolution of opportunities identified via the data analysis, assign a score of one (1). If not, the score should remain at zero (0)”. When the assessor highlights the corresponding cell represented as letter (X), the software tool 20 displays to the assessor: “If there is evidence that the Manager's working files have been actively maintained and contain all required records, assign a score of one (1). If not, the score should remain at zero (0)”.

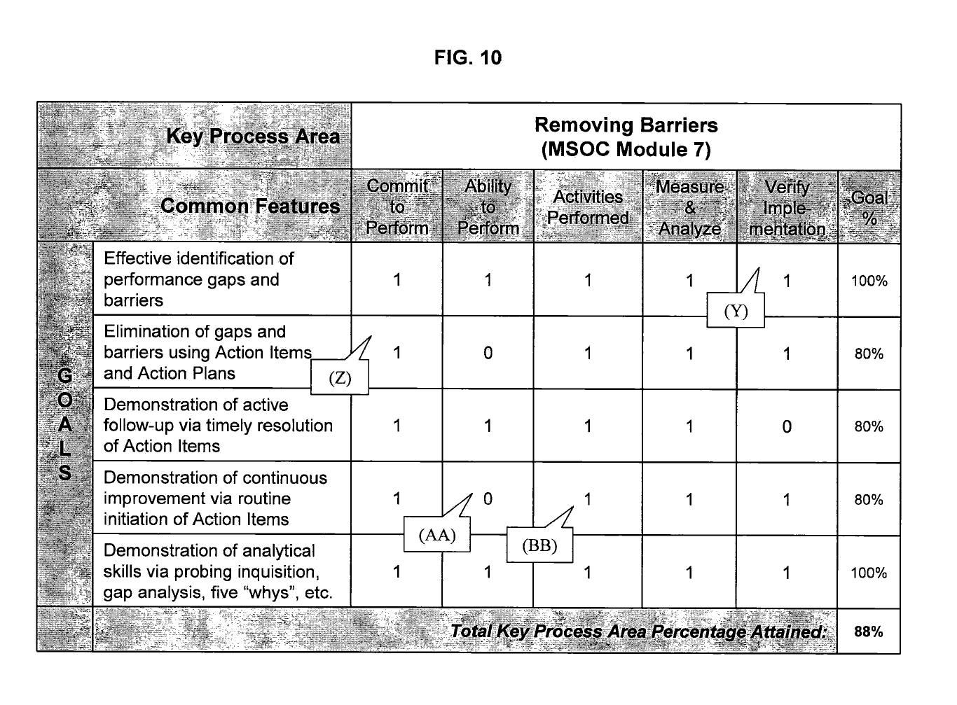

FIG. 10 illustrates “Removing Barriers” which is MSOC Module 7 of the key process areas 120 in accordance with exemplary embodiments. The software tool 20 displays Module 7 of the KPA 120 to the assessor to receive input data 125, and the software tool 20 may display part and/or all the following instructions to assist the assessor: “you must confirm the active and ongoing administration of action items and completion of action plans.”

For the key process area “Removing Barriers” of MSOC Module 7, the software tool 20 is configured to display instructions on the display 45 that ask the assessor to include, e.g., at a minimum, the following components when completing your assessment: “1) Ensure that the Manager encourages all employees to identify performance gaps and work barriers so that appropriate action may be taken to eliminate problem areas. 2) Verify that Action Items are created on a routine and recurring basis, and that Action Plans are actively managed. 3) Determine if evidence exists to support the assumption that problems are being actively analyzed and resolved by the Manager. 4) Review Action Items for clarity of description. 5) Review Action Plans for clarity of description and comprehensive inclusion of all resolution related detail.”

In FIG. 10, the assessor via a GUI of the software tool 20 inputs ones (1) and zeros (0) as the input data 125 into the matrix by using the user interface 50. As discussed above, the software tool 20 calculates row goal percentages for each of the goals, and determines a total key process area percentage attained of 88% for the evaluated Module 7. Based on the calculated total key process area percentage attained (88%), the software tool 20 determines that the KPA 120 for “Removing Barriers” Module 7 is assigned to CMM level 3 and displays the CMM level to the assessor.

Further as the assessor is evaluating the organization using the displayed matrix of the KPA 120, the assessor can utilize the user interface 50 to select a cell in the matrix of the software tool 20 on the display 45. When the assessor highlights the corresponding cell represented as letter (Y), the software tool 20 displays to the assessor: “If there is evidence on file that the supervisors and subordinates are actively identifying and routinely removing barriers to completing assigned work, assign a score of one (1). If not, the score should remain at zero (0)”. When the assessor highlights the corresponding cell represented as letter (Z), the software tool 20 displays to the assessor: “If there is evidence that employees are actively engaged in the elimination of process problems through the use of Action Items and Action Plans, assign a score of one (1). If not, the score should remain at zero (0)”. When the assessor highlights the corresponding cell represented as letter (AA), the software tool 20 displays to the assessor: “If there is evidence that reports are generated and are effectively analyzed to identify opportunities for improving operations, and that all levels of management are engaged in the resolution of opportunities identified via the data analysis, assign a score of one (1). If not, the score should remain at zero (0)”. When the assessor highlights the corresponding cell represented as letter (BB), the software tool 20 displays to the assessor: “If there is evidence that the Manager's working files have been actively maintained and contain all required records, assign a score of one (1). If not, the score should remain at zero (0)”.

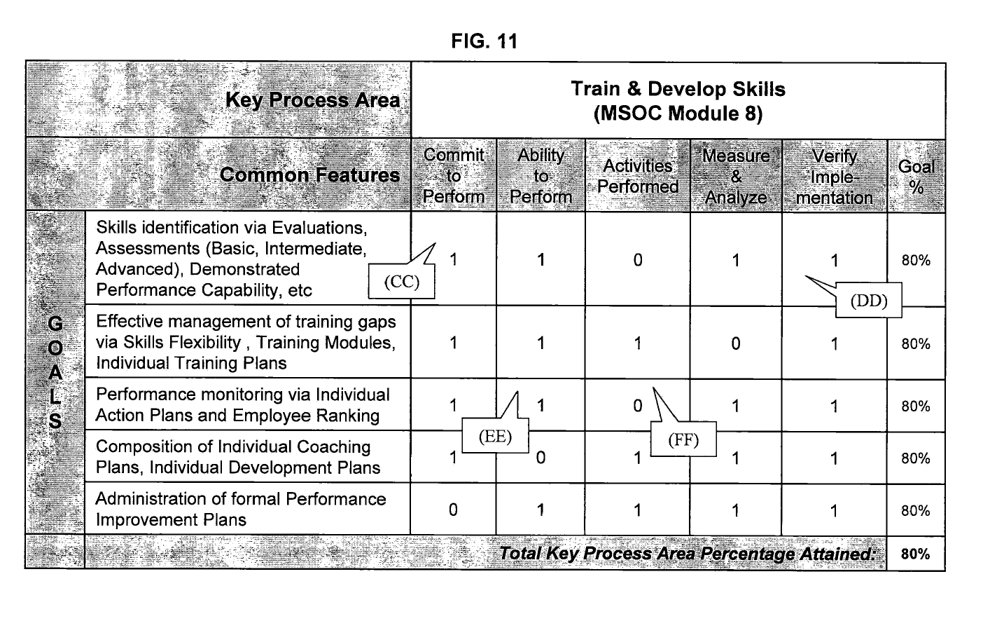

FIG. 11 illustrates “Train and Develop Employee Skills” which is MSOC Module 8 of the key process areas 120 in accordance with exemplary embodiments. The software tool 20 displays Module 8 of the KPA 120 to the assessor to receive input data 125, and the software tool 20 may display part and/or all the following instructions to assist the assessor: “You should confirm that the Supervisor has completed an effective assessment of employee skills and has put in place the components necessary to execute a skills improvement program when necessary; you should also assess the capabilities of the supervisor's subordinates to verify that the programs in place are sufficient to optimize the skill sets of the employees.”

For the key process area “Train and Develop Employee Skills” of MSOC Module 8, the software tool 20 is configured to display instructions on the display 45 that ask the assessor to include, e.g., at a minimum, the following components when completing your assessment: “1) Ensure that Managers complete the appropriate quantity of evaluations, assessments, and direct observations of work completed by their subordinates. 2) Confirm that gaps in training are being identified. When gaps in training are identified, ensure that the Manager is addressing the issue. 3) Verify that there is an ongoing program that requires the continuous monitoring of performance, the identification of improvement opportunities, and the resolution of problem areas. 4) Verify that employees that demonstrate unsatisfactory performance are appropriately managed, including completion of required documentation within the prescribed time constraints. 5) Ensure that the Manager has provided all employees the opportunity to establish an Individual Development Plan.”

In FIG. 11, the assessor via a GUI of the software tool 20 inputs ones (1) and zeros (0) as the input data 125 into the matrix by using the user interface 50. The software tool 20 calculates row goal percentages for each of the goals and determines a total key process area percentage attained of 80% for the evaluated Module 8. Based on the calculated total key process area percentage attained (80%), the software tool 20 determines that the KPA 120 for “Train and Develop Skills” Module 8 is assigned to CMM level 2 and displays the CMM level to the assessor.

Further as the assessor is evaluating the organization using the displayed matrix of the KPA 120, the assessor can utilize the user interface 50 to select a cell in the matrix of the software tool 20 on the display 45. When the assessor highlights the corresponding cell represented as letter (CC), the software tool 20 displays to the assessor: “If there is evidence that the Manager is actively engaged in the assessment and development of employee skills, assign a score of one (1). If not, the score should remain at zero (0)”. When the assessor highlights the corresponding cell represented as letter (DD), the software tool 20 displays to the assessor: “If there is evidence on file that the Managers are actively monitoring employee performance and addressing training gaps improve performance, assign a score of one (1). If not, the score should remain at zero (0)”. When the assessor highlights the corresponding cell represented as letter (EE), the software tool 20 displays to the assessor: “If there is evidence that reports are generated and are effectively analyzed to identify opportunities for improving employee skills, and that all levels of management are engaged in the resolution of opportunities identified via the data analysis, assign a score of one (1). If not, the score should remain at zero (0)”. When the assessor highlights the corresponding cell represented as letter (FF), the software tool 20 displays to the assessor: “If there is evidence that the Manager's working files have been actively maintained and contain all required records, assign a score of one (1). If not, the score should remain at zero (0)”.

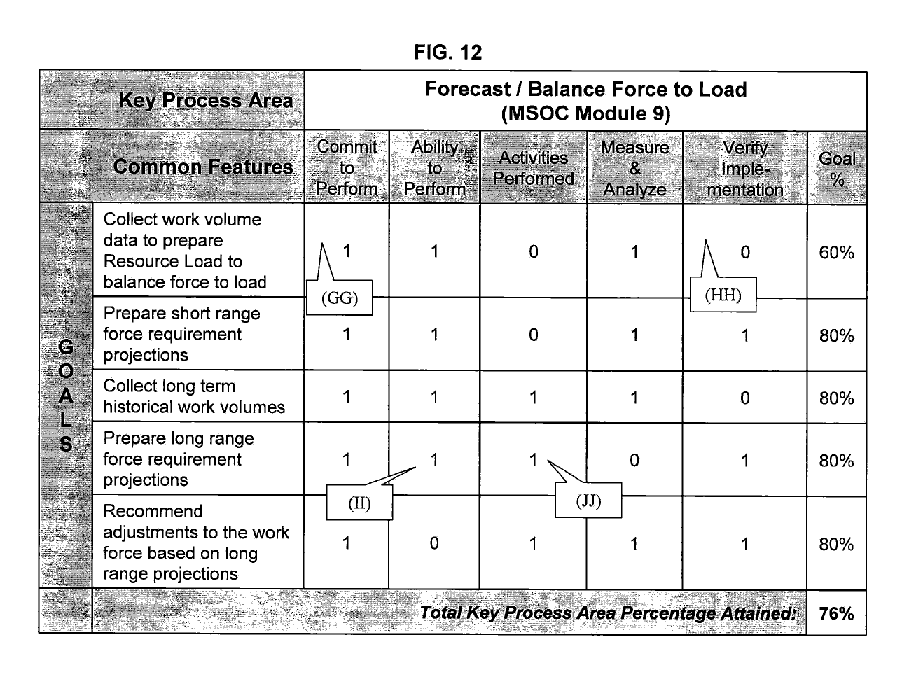

FIG. 12 illustrates “Forecast and Balance Force to Load” which is MSOC Module 9 of the key process areas 120 in accordance with exemplary embodiments. The software tool 20 displays Module 9 of the KPA 120 to the assessor to receive input data 125, and the software tool 20 may display part and/or all the following instructions to assist the assessor: “You should determine the effectiveness of any force forecasting tools in place in terms of completeness, accuracy, and actual application within the workplace.”

For the key process area “Forecast and Balance Force to Load” of MSOC Module 9, the software tool 20 is configured to display instructions on the display 45 that ask the assessor to include, e.g., at a minimum, the following components when completing your assessment: “1) Ensure that Managers are monitoring work volumes and making appropriate adjustments to the work force as fluctuations in volume are experienced. 2) Confirm that the managers are preparing and/or have prepared short range forecasts of work activity that may be used to appropriately size the work force to manage the work load. 3) Verify that there is an ongoing program to collect long-term historical work volumes for the production of trend data and future forecasts. 4) Verify that the managers are preparing and/or have prepared long range forecasts of work activity that may be used to appropriately forecast the work force to manage the future work load. 5) Confirm that Managers make appropriate recommendation regarding adjustments both increases and decreases to the work force, based upon analysis of trend data and prepared forecasts.”

In FIG. 12, the assessor via a GUI of the software tool 20 inputs ones (1) and zeros (0) as the input data 125 into the matrix by using the user interface 50. The software tool 20 calculates row goal percentages for each of the goals and determines a total key process area percentage attained of 76% for the evaluated Module 9. Based on the calculated total key process area percentage attained (76%), the software tool 20 determines that the KPA 120 for “Forecast and Balance Force to Load” Module 9 is assigned to CMM level 2 and displays the CMM level to the assessor.

Further as the assessor is evaluating the organization using the displayed matrix of the KPA 120, the assessor can utilize the user interface 50 to select a cell in the matrix of the software tool 20 on the display 45. When the assessor highlights the corresponding cell represented as letter (GG), the software tool 20 displays to the assessor: “If there is evidence that the Manager is actively engaged in the analysis of work volume data in an effort to model the required work force, assign a score of one (1). If not, the score should remain at zero (0)”. When the assessor highlights the corresponding cell represented as letter (HH), the software tool 20 displays to the assessor: “If there is evidence on file that the Managers are actively monitoring work volumes and adjusting the available work force to match the work load, assign a score of one (1). If not, the score should remain at zero (0)”. When the assessor highlights the corresponding cell represented as letter (II), the software tool 20 displays to the assessor: “If there is evidence that reports are generated and are effectively analyzed to identify opportunities for matching work force to the projected work load, and that all levels of management are engaged in the resolution of opportunities identified via the data analysis, assign a score of one (1). If not, the score should remain at zero (0)”. When the assessor highlights the corresponding cell represented as letter (JJ), the software tool 20 displays to the assessor: “If there is evidence that the Manager's working files have been actively maintained and contain all required records, assign a score of one (1). If not, the score should remain at zero (0)”.

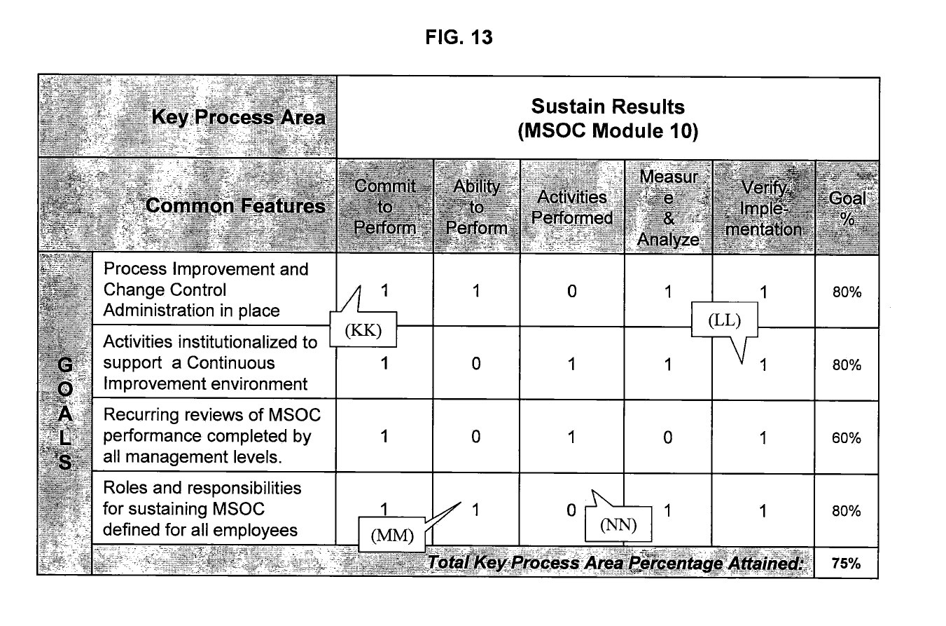

FIG. 13 illustrates “Sustain Results” which is MSOC Module 10 of the key process areas 120 in accordance with exemplary embodiments. The software tool 20 displays Module 10 of the KPA 120 to the assessor to receive input data 125, and the software tool 20 may display part and/or all the following instructions to assist the assessor: “you should confirm that there is a continuous review process in place to ensure that fosters an environment of continuous improvement.”

For the key process area “Sustain Results” of MSOC Module 10, the software tool 20 is configured to display instructions on the display 45 that ask the assessor to include, e.g., at a minimum, the following components when completing your assessment: “1) Ensure that Managers at all levels of the organization are actively managing the files impacted by changes in process and process improvements. 2) Confirm that the leadership team, e.g. level 2 managers and above, are actively engaged and hold subordinates accountable of completion of prescribed MSOC practices. 3) Verify that there is an ongoing program to complete recurring operational reviews of MSOC activities required at all levels of management. 4) Verify that MSOC roles and responsibilities are defined at every level of management, including required tasks, frequency of completion, and expectations to be met when issues surface.”

In FIG. 13, the assessor via a GUI of the software tool 20 inputs ones (1) and zeros (0) as the input data 125 into the matrix by using the user interface 50. The software tool 20 calculates row goal percentages for each of the goals and determines a total key process area percentage attained of 75% for the evaluated Module 10. Based on the calculated total key process area percentage attained (75%), the software tool 20 determines that the KPA 120 for “Forecast and Balance Force to Load” Module 9 is assigned to CMM level 2 and displays the CMM level to the assessor.

Further as the assessor is evaluating the organization using the displayed matrix of the KPA 120, the assessor can utilize the user interface 50 to select a cell in the matrix of the software tool 20 on the display 45. When the assessor highlights the corresponding cell represented as letter (KK), the software tool 20 displays to the assessor: “If there is evidence that the Manager is actively engaged in the process improvement and change control, assign a score of one (1). If not, the score should remain at zero (0)”. When the assessor highlights the corresponding cell represented as letter (LL), the software tool 20 displays to the assessor: “If there is evidence on file that the Managers at all levels of the organization are actively monitoring performance, assign a score of one (1). If not, the score should remain at zero (0)”. When the assessor highlights the corresponding cell represented as letter (MM), the software tool 20 displays to the assessor: “If there is evidence that roles and responsibilities of sustaining MSOC are defined for all levels of management, and that all levels of management are engaged in the resolution of opportunities identified via the program, assign a score of one (1). If not, the score should remain at zero (0)”. When the assessor highlights the corresponding cell represented as letter (NN), the software tool 20 displays to the assessor: “If there is evidence that the Manager's working files at all levels of management have been actively maintained and contain all required records, assign a score of one (1). If not, the score should remain at zero (0)”.

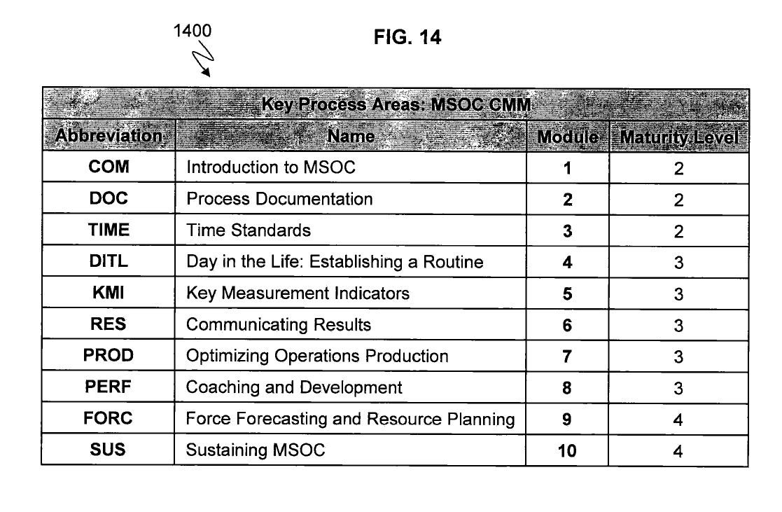

FIG. 14 illustrates an MSOC CMM chart 1400 in accordance with exemplary embodiments. The MSOC CMM chart 1400 contains ten process areas indicating aspects of operation proficiency. For each Module 1-10, the MSOC CMM chart 1400 shows acceptable maturity levels for each of the key process areas 120, according to one implementation. It is understood that different acceptable maturity levels may be developed.

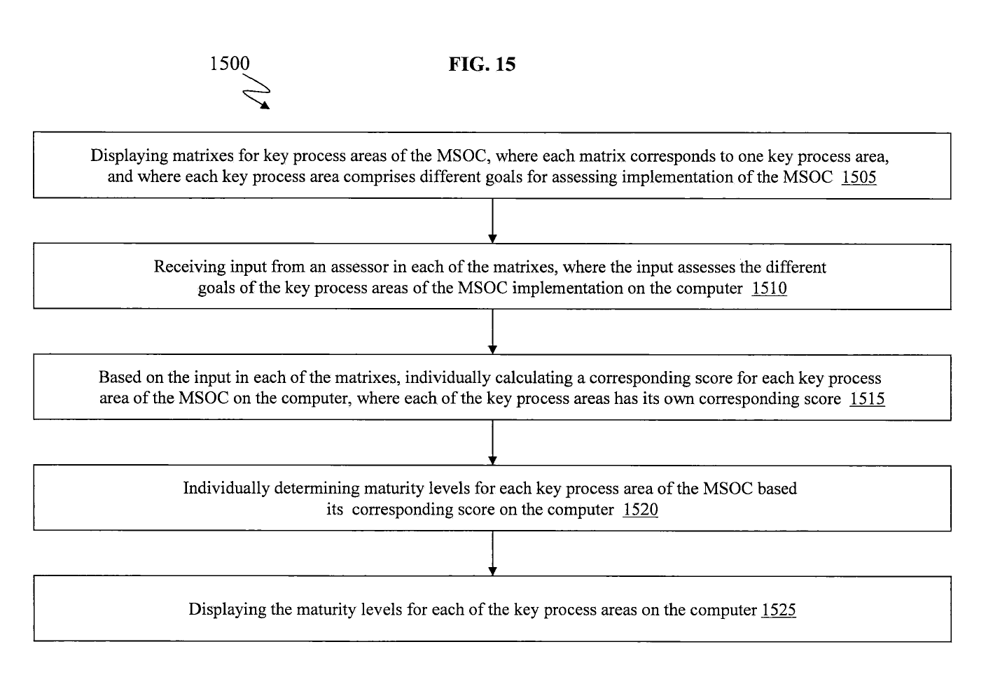

FIG. 15 illustrates a process 1500 for assessing implementation of management system and operating control (MSOC) by an organization utilizing the software tool 20 in accordance with exemplary embodiments.

At operation 1505, the software tool 20 is configured to progressively display matrixes for key process areas 120, e.g., Modules 1-10 of the MSOC on the display 45 of the computing device 10. Each of the matrixes corresponds to one of the key process areas 120 as shown in FIGS. 4-13, and each of the key process areas 120 comprises different goals for assessing implementation of the MSOC.

At operation 1510, the software tool 20 is configured to receive input from the assessor in each of the matrixes, where the input, e.g., input data 125, assesses the different goals of the key process areas 120 of the MSOC implementation.

At operation 1515, based on the input in each of the matrixes, the software tool 20 is configured to individually calculate a corresponding total score for each of the key process areas 120 of the MSOC, where each of the key process areas 120 has its own corresponding total score, e.g., shown at the bottom right of the KPAs 120 in FIGS. 4-13 as total key process area percentage attained.

At operation 1520, the software tool 20 is configured to individually determine maturity levels for each of the key process areas 120 of the MSOC based on the corresponding total score.

At operation 1525, the software tool 20 is configured to display the determined maturity levels for each of the key process areas 120.

Further, the key process areas are divided into Modules for display to the assessor such that each of the key process areas corresponds to one of the Modules. The software tool 20 is configured to display the Modules 1-10 to the assessor to receive the input, e.g., the input data 125, and the software tool 20 is configured to display instructions for each of the key process areas 120 as the assessor progresses through the Modules 1-10. The software tool 20 is configured to display individual instructions for the cells of the matrixes as the assessor identifies, e.g., highlights, one of the cells, and the individual instructions guide the assessor on how to assess whether the different goals of the MSOC are being achieved. For each of the key process areas 120, the software tool 20 of the computer 10 calculates a score based on an amount of ones and an amount of zeros received for each of the key process areas 120.

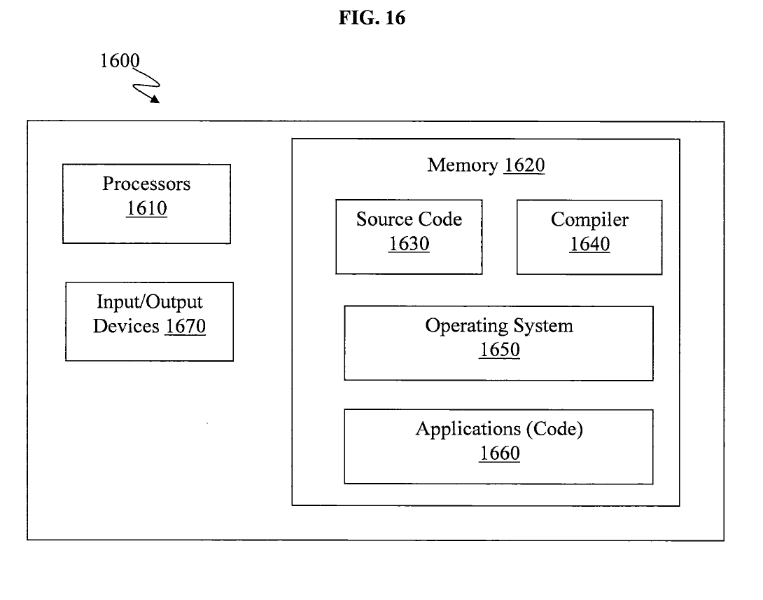

FIG. 16 illustrates an example of a computer 1600 that may be utilized in implementing exemplary embodiments. The computer 1600 includes, but is not limited to, PCs, workstations, systems, laptops, PDAs, palm devices, tablets, servers, mobile devices, communication devices, cell phones, computer systems, set top boxes (STB), televisions (TV), game consoles, MP3 players, and the like. The computer 1600 may include one or more processors 1610, memory 1620, and one or more input and/or output (I/O) 1670 devices (or peripherals) that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 1610 is a hardware device for executing software that can be stored in computer readable storage memory 1620. The processor 1610 can be virtually any custom made or commercially available processor, a central processing unit (CPU), a data signal processor (DSP), or an auxiliary processor among several processors associated with the computer 1600, and the processor 1610 may be a semiconductor based microprocessor (in the form of a microchip) or a macroprocessor.

The computer readable storage memory 1620 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the computer readable storage memory 1620 may incorporate electronic, magnetic, optical, and/or other types of storage media. Note that the computer readable storage memory 1620 can have a distributed architecture, where various components are situated remote from one another, but can be accessed by the processor 1610.

The software in the computer readable storage memory 1620 may include one or more separate programs, each of which comprises an ordered listing of executable instructions for implementing logical functions. In the example illustrated in FIG. 16, the software in the computer readable storage memory 1620 includes a suitable operating system (O/S) 1650, compiler 1640, source code 1630, and one or more applications 1660 (or Modules) of the exemplary embodiments.

The operating system 1650 controls the execution of other computer programs, and provides scheduling, input-output control, file and data management, memory management, and communication control and related services. It is contemplated by the inventors that the application 1660 for implementing exemplary embodiments is applicable on all other commercially available operating systems.

The application 1660 may be a source program, executable program (object code), script, or any other entity comprising a set of instructions to be performed. When a source program is to be executed, then the program is usually translated via a compiler (such as the compiler 1640), assembler, interpreter, or the like, which may or may not be included within the computer readable storage memory 1620, so as to operate properly in connection with the O/S 1650. Furthermore, the application 1660 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 1670 may include input devices such as, for example but not limited to, a mouse, keyboard, scanner, microphone, remote controller, camera, biometric input device(s), a vibrator device for non-audible alert, etc. Furthermore, the I/O devices 1670 may also include output devices, for example but not limited to, a printer, display, speaker, etc. Also, the I/O devices 1670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 1670 include may include modems, gateways, receivers, transmitters, transceivers, etc. for communicating over a communications network.

When the computer 1600 is in operation, the processor 1610 is configured to execute software stored within the computer readable storage memory 1620, to communicate data to and from the memory 1620, and to generally control operations of the computer 1600 pursuant to the software. The application 1660 and the O/S 1650 are read, in whole or in part, by the processor 1610, perhaps buffered within the processor 1610, and then executed.

When the application 1660 is implemented in software, it should be noted that the application 1660 can be stored on virtually any computer readable storage memory for use by or in connection with any computer related system or method. In the context of this document, a computer readable storage memory may be an electronic, magnetic, optical, or other physical device or means that can contain or store a computer program for use by or in connection with a computer related system or method.

The application 1660 can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, computer programs tangibly embodied on a computer-readable storage medium can be stored, communicated, propagated, or transported for use by or in connection with the instruction execution system, apparatus, or device.

More specific examples (a nonexhaustive list) of the computer-readable storage medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 1660 is implemented in hardware, the application 1660 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a computer readable storage medium, loaded into and/or executed by a computer. When the computer program code is loaded into an executed by a computer, the computer becomes an apparatus for practicing the exemplary embodiments. When implemented on a general-purpose microprocessor, the computer program code segments configure the microprocessor to create specific logic circuits. It is understood that computer program code can be transmitted over some transmission medium, loaded into and/or executed by a computer, or transmitted over some transmission medium, such as over electrical wiring or cabling, through fiber optics, or via electromagnetic radiation.

While features have been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the present disclosure without departing from the essential scope thereof. Therefore, it is intended that the present disclosure not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for assessing implementation of management system and operating control (MSOC) by an organization on a computer, comprising:
displaying matrixes for key process areas of the MSOC on the computer, wherein each of the matrixes corresponds to one of the key process areas, and wherein each of the key process areas comprises different goals for assessing implementation of the MSOC;
receiving input from an assessor in each of the matrixes, wherein the input assesses the different goals of the key process areas of the MSOC implementation on the computer;
based on the input in each of the matrixes, individually calculating a corresponding score for each of the key process areas of the MSOC on the computer, wherein each of the key process areas has its own corresponding score;
individually determining maturity levels for each of the key process areas of the MSOC based on the corresponding score on the computer; and
displaying the maturity levels for each of the key process areas on the computer.

2. The method of claim 1, wherein the key process areas are divided into Modules for display to the assessor such that each of the key process areas corresponds to one of the Modules.

3. The method of claim 1, wherein the key process areas comprise ten Modules for display to the assessor.

4. The method of claim 2, wherein Modules are displayed to the assessor to receive the input; and
wherein the Modules comprise assessments for at least one of: introduction to the MSOC, process documentation, time standards, establishing a routine, analyze data, communicate results, removing barriers, train and develop employee skills, forecast and balance force to load, and sustain results.

5. The method of claim 1, further comprising displaying instructions for each of the key process areas.

6. The method of claim 1, further comprising displaying instructions for each of the key process areas as the assessor progresses from a first key process area to a last key process area.

7. The method of claim 1, further comprising displaying individual instructions for the cells of the matrixes as the assessor identifies one of the cells; and
wherein the individual instructions guide the assessor on how to assess whether the different goals of the MSOC are being achieved.

8. The method of claim 1, wherein the maturity levels comprise level 1, level 2, level 3, and level 4.

9. The method of claim 8, wherein level 4 is a highest and level 1 is a lowest.

10. The method of claim 8, wherein the computer determines if each of the key process areas receives a level 1, level 2, level 3, and level 4 based on the corresponding score for each of the key process areas.

11. The method of claim 1, wherein cells of the matrix have a default input of zero.

12. The method of claim 1, wherein for each of the different goals the input from the assessor is a one or a zero; and
wherein the one corresponds to the different goals being achieved and the zero corresponds to the different goals not being achieved.

13. The method of claim 1, wherein for each of the key process areas the computer calculates the score based on an amount of ones and an amount of zeros received for each of the key process areas.

14. The method of claim 1, wherein the different goals are the descriptions of a state that should exist for an effective and lasting implementation of the MSOC;
wherein the different goals signify a scope, a boundary, and an intent of each of the key process areas for the MSOC; and
wherein an extent to which the different goals have been accomplished is an indicator of how much capability the organization has established of the MSOC.

15. A computer for assessing implementation of management system and operating control (MSOC) by an organization, comprising:
memory for storing a program; and
a processor, functionally coupled to the memory, the processor being responsive to computer-executable instructions contained in the program and operative for:
displaying matrixes for key process areas of the MSOC on the computer, wherein each of the matrixes corresponds to one of the key process areas, and wherein each of the key process areas comprises different goals for assessing implementation of the MSOC;
receiving input from an assessor in each of the matrixes, wherein the input assesses the different goals of the key process areas of the MSOC implementation on the computer;
based on the input in each of the matrixes, individually calculating a corresponding score for each of the key process areas of the MSOC on the computer, wherein each of the key process areas has its own corresponding score;
individually determining maturity levels for each of the key process areas of the MSOC based on the corresponding score on the computer; and
displaying the maturity levels for each of the key process areas on the computer.

16. The computer of claim 15, wherein the processor is configured to divide the key process areas into Modules for display to the assessor such that each of the key process areas corresponds to one of the Modules.

17. The computer of claim 16, wherein processor is configured to display Modules to the assessor to receive the input; and
wherein the Modules comprise assessments for at least one of: introduction to the MSOC, process documentation, time standards, establishing a routine, analyze data, communicate results, removing barriers, train and develop employee skills, forecast and balance force to load, and sustain results.

18. The computer of claim 15, wherein the processor is configured to calculate the score for each of the key process areas based on an amount of ones and an amount of zeros received for each of the key process areas.

19. The computer of claim 15, wherein the processor is configured display instructions for each of the key process areas.

20. A computer program product, tangibly embodied on a non-transitory computer readable medium, the computer program product including instructions for causing a computer to execute a method for assessing implementation of management system and operating control (MSOC) by an organization, comprising:
displaying matrixes for key process areas of the MSOC on the computer, wherein each of the matrixes corresponds to one of the key process areas, and wherein each of the key process areas comprises different goals for assessing implementation of the MSOC;
receiving input from an assessor in each of the matrixes, wherein the input assesses the different goals of the key process areas of the MSOC implementation on the computer;
based on the input in each of the matrixes, individually calculating a corresponding score for each of the key process areas of the MSOC on the computer, wherein each of the key process areas has its own corresponding score;
individually determining maturity levels for each of the key process areas of the MSOC based on the corresponding score on the computer; and
displaying the maturity levels for each of the key process areas on the computer.
